(19) United States
(12) Patent Application Publication
(10) Pub. No.: US 2024/0244710 A1
(43) Pub. Date: Jul. 18, 2024

(54) METHOD AND APPARATUS FOR INACTIVITY TIMER HANDLING

(71) Applicant: LENOVO (BEIJING) LIMITED, Beijing (CN)

(72) Inventors: Jing Han, Beijing (CN); Ran Yue, Beijing (CN); Jie Hu, Beijing (CN); Lianhai Wu, Beijing (CN); Haiming Wang, Beijing (CN)

(21) Appl. No.: 18/560,220

(22) PCT Filed: May 10, 2021
(86) PCT No.: PCT/CN2021/092782

§ 371 Date: Nov. 10, 2023

(51) Int. Cl. H04W 76/38; H04W 72/40; H04W 72/543; H04W 76/14

(52) U.S. Cl. CPC H04W 76/38; H04W 72/40; H04W 72/543; H04W 76/14

(57) ABSTRACT

A method and an apparatus for inactivity timer handling. The method includes: selecting at least one LCH for transmitting sidelink data to another user equipment; determining whether to start an inactivity timer, which is enabled, for the transmission of the sidelink data based on an inactivity timer configuration of at least one QoS of the at least one LCH contained in the sidelink data; and if it is determined to start the inactivity timer, starting the inactivity timer for the transmission of the sidelink data.

### TECHNICAL FIELD

Embodiments of the present application generally relate to wireless communication technology, especially to a method and an apparatus for inactivity timer handling under 3GPP (3rd Generation Partnership Project) 5G new radio (NR).

### BACKGROUND

With network developments of 3rd Generation Partnership Project (3GPP) 5G New Radio (NR), sidelink transmission between user equipment is developed. For power saving, discontinuous reception (DRX) scheme is introduced for sidelink transmission. DRX scheme for sidelink transmission is configured with several timers. One of the timers is inactivity timer which is used to extend active time for reception of continuously data, especially for aperiodic data transmission. User equipment in a sidelink transmission group should have the same understanding for inactivity timer status. However, inactivity timer status may not be kept aligned among all user equipment in the sidelink transmission group sometimes.

### SUMMARY

Some embodiments of the present application provide a method of a user equipment. The method includes: selecting at least one logical channel (LCH) for transmitting sidelink data to another user equipment; determining whether to start an inactivity timer, which is enabled, for the transmission of the sidelink data based on an inactivity timer configuration of at least one quality of service (QOS) of the at least one LCH contained in the sidelink data; and if it is determined to start the inactivity timer, starting the inactivity timer for the transmission of the sidelink data.

Some embodiments of the present application provide a method of a user equipment. The method includes: receiving a sidelink control information (SCI) from another user equipment; and determining whether to start an inactivity timer according to the reception of the SCI.

Some embodiments of the present application provide an apparatus. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method for wireless communications.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates a schematic diagram of message transmission in accordance with some embodiments of the present application;

FIG. 3A illustrates a schematic diagram of a wireless communication system in accordance with some embodiments of the present application;

FIG. 3B illustrates a schematic diagram of a wireless communication system in accordance with some embodiments of the present application;

FIG. 3C illustrates a schematic diagram of a wireless communication system in accordance with some embodiments of the present application;

FIG. 3D illustrates a schematic diagram of a wireless communication system in accordance with some embodiments of the present application;

FIGS. 4A to 4C illustrate flow charts of a method for wireless communications according to an embodiment of the present disclosure.

FIG. 5 illustrates a flow chart of a method for wireless communications according to an embodiment of the present disclosure.

FIG. 6 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

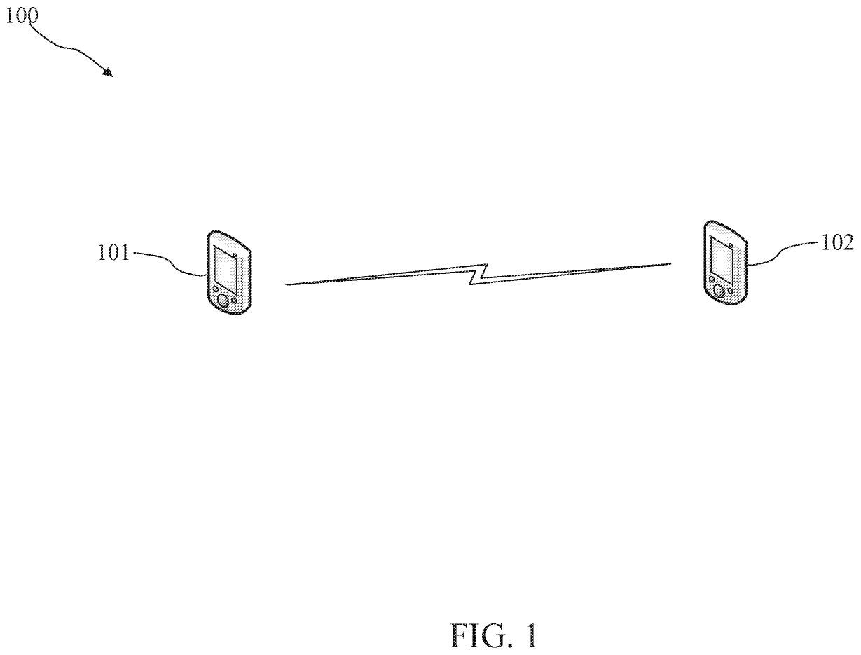

FIG. 1 illustrates a schematic diagram of a wireless communication system 100 in accordance with some embodiments of the present application. The wireless communication system 100 includes a user equipment (UE) 101 and a UE 102. Although a specific number of UEs 101 and 102 are depicted in FIG. 1, it is contemplated that any number of UE, base station (BS) and core network (CN) may be included in the wireless communication system 100.

UEs 101 and 102 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems). Internet of Thing (IoT) devices, or the like.

According to some embodiments of the present application, UEs 101 and 102 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, UEs 101 and 102 may include, for example, but is not limited to, wearable devices, such as smart watches, fitness bands, optical head-mounted displays, or the like. Moreover. UEs 101 and 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UEs 101 and 102 may communicate with each other via sidelink transmission.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

According to existing agreements, discontinuous reception (DRX) scheme for sidelink transmission is configured with several timers. One of the timers is inactivity timer which is used to extend active time for reception of continuously data, especially for aperiodic data transmission. UE in the same sidelink transmission group should have the same understanding for inactivity timer status. However, inactivity timer status may not be kept aligned among all UE in the sidelink transmission group sometimes.

Accordingly, in the present disclosure, conditions for UEs in the same sidelink transmission group to determine whether to enable inactivity timer may be introduced. More details on embodiments of the present disclosure will be further described hereinafter.

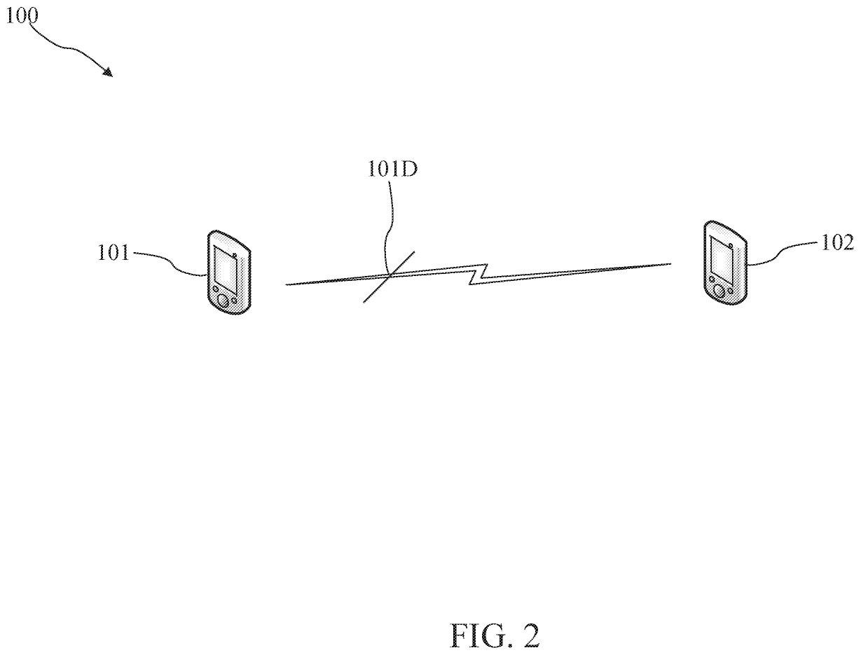

FIG. 2 is a schematic diagram of message transmission in accordance with some embodiments of the present application. In some embodiments. UE 101 may transmit sidelink data 101D to UE 102 and may determine whether to start an inactivity timer for the transmission of the sidelink data 101D.

In particular. UE 101 may be pre-configured with an inactivity timer, which is enabled (e.g., configured with a dedicated inactivity timer or configured with an inactivity timer which has a value greater than zero), for partial of quality of service (QOS) profiles. Therefore, for data communication associated with these QoS profiles. UE 101 may need to handle the inactivity timer.

When UE 101 needs to transmit the sidelink data 101D to UE 102. UE 101 may select at least one logical channel (LCH) for transmitting the sidelink data 101D. In detail, UE 101 may process sidelink grant first. After UE 101 processes the sidelink grant, UE 101 may perform a logical channel prioritization (LCP) procedure to multiplex data into the sidelink grant. During the LCP procedure, the at least one LCH with data and fulfilling transmission conditions may be selected and multiplexed into the sidelink grant by UE 101.

Next. UE 101 may determine whether to start the inactivity timer, which is enabled, for the transmission of the sidelink data 101D based on an inactivity timer configuration of the at least one QoS of the at least one LCH contained in the sidelink data 101D.

In some embodiments, the inactivity timer configuration may be used to configure UE 101 to determine to start the inactivity timer for the transmission of the sidelink data based on that: (1) a specific QoS of a specific LCH of the at least one LCH is configured with the inactivity timer; or (2) every QoS of the at least one LCH is configured with the inactivity timer.

In some implementations, the specific QoS of the specific LCH of the at least one LCH being configured with the inactivity timer may be: (1) if any LCH of the at least one LCH is associated with QoS that configured with inactivity timer; (2) if the LCH with highest priority is associated with QoS that configured with the inactivity timer; or (3) if one LCH whose priority value is higher than a threshold is associated with QoS that configured with the inactivity timer.

Accordingly, for example, UE 101 determines to start the inactivity timer for the transmission of the sidelink data 101D based on that: (1) when one of the at least one LCH is associated with QoS that configured with inactivity timer; (2) when the LCH with highest priority is associated with QoS that configured with the inactivity timer; or (3) when one LCH whose priority value is higher than a threshold is associated with QoS that configured with the inactivity timer.

In some implementations, every QoS of the at least one LCH being configured with the inactivity timer may be: if all of the at least one LCH is associated with QoS that configured with the inactivity timer. Accordingly, for example, UE 101 determines to start the inactivity timer for the transmission of the sidelink data 101D based on that: when all of the at least one LCH is associated with QoS that configured with the inactivity timer.

In some embodiments, a new LCP restriction may be introduced when UE 101 starts the inactivity timer for the partial of QoS profiles. In particular, when UE 101 determine to generate another sidelink grant during a duration of that only the inactivity timer is running. UE 101 may select at least one specific LCH for generating the sidelink grant, and the at least one specific LCH may be configured with the inactivity timer.

For example, there are LCH “#1”, LCH “#2”, LCH “#3” associated with QoS profiles that configured with the inactivity timer and LCH “#4”, LCH “#5” associated with QoS profiles that configured without the inactivity timer (or configured with the inactivity timer whose value is zero). When the another sidelink grant happens during a duration of that only the inactivity timer is running, only LCH “#1”, LCH “#2”, LCH “#3” can be selected during the LCP procedure and multiplexed into the another sidelink grant but LCH “#4”, LCH “#5” cannot be selected and multiplexed. On the other hand, when the another sidelink grant happens during a duration of that not only the inactivity timer is running but also on-duration timer or retransmission timer is running, all LCHs (“#1”, “#2”, “#3”, “#4”, “#5”) are allowed to be selected during the LCP procedure and multiplexed into the another sidelink grant.

In some embodiments. UE 101 may determine to perform a resource selection/re-selection for another LCH. The resource(s) during a duration of that only the inactivity timer is running may be selected/re-selected when the another LCH is configured with the inactivity timer. The resource(s) during the duration of that only the inactivity timer is running may not be selected/re-selected when the another LCH is not configured with the inactivity timer.

For example, there are LCH “#a”, LCH “#b”, LCH “#c” associated with QoS profiles that configured with the inactivity timer and LCH “#d”, LCH “#e” associated with QoS profiles that configured without the inactivity timer (or configured with the inactivity timer whose value is zero). When LCH “#d” or LCH “#e” has arrived data for transmission and resource needs to be selected/re-selected, only the resource during a duration of that the on-duration timer or retransmission timer is running can be selected/re-selected but the resource during a duration of that the inactivity timer is running cannot be selected/re-selected. On the other hand, when LCH “#a”. LCH “#b” or LCH “#c” has arrived data for transmission and resource needs to be selected/re-selected, the resource during a duration of that the on-duration timer, the retransmission timer or the inactivity timer is running can be selected/re-selected.

In some embodiments, new active time definition may be introduced. In particular, an active time definition is per LCH. For a specific LCH configured with the inactivity timer, the active time definition includes a duration of that the inactivity timer is running. For another specific LCH not configured with the inactivity timer, the active time definition does not include a duration of that the inactivity timer is running.

For example, there are LCH “#x”, LCH “#y”, LCH “#z” associated with QoS profiles that configured with inactivity timer and LCH “#p”, LCH “#q” associated with QoS profiles that configured without the inactivity timer (or configured with the inactivity timer whose value is zero). Active time definition for LCH “#1”. LCH “#2”, LCH “#3” includes: (1) the on-duration timer is running; (2) the retransmission timer is running; and (3) the inactivity timer is running. Active time definition for LCH “#p”, LCH “#q” includes: (1) the on-duration timer is running; and (2) retransmission timer is running. In other words, the inactivity timer being running cannot not be counted as the active time for LCH “#p”. LCH “#q”.

In some embodiments, when UE 101 determine to start the inactivity timer. UE 101 may indicate UE 102 to start the inactivity timer.

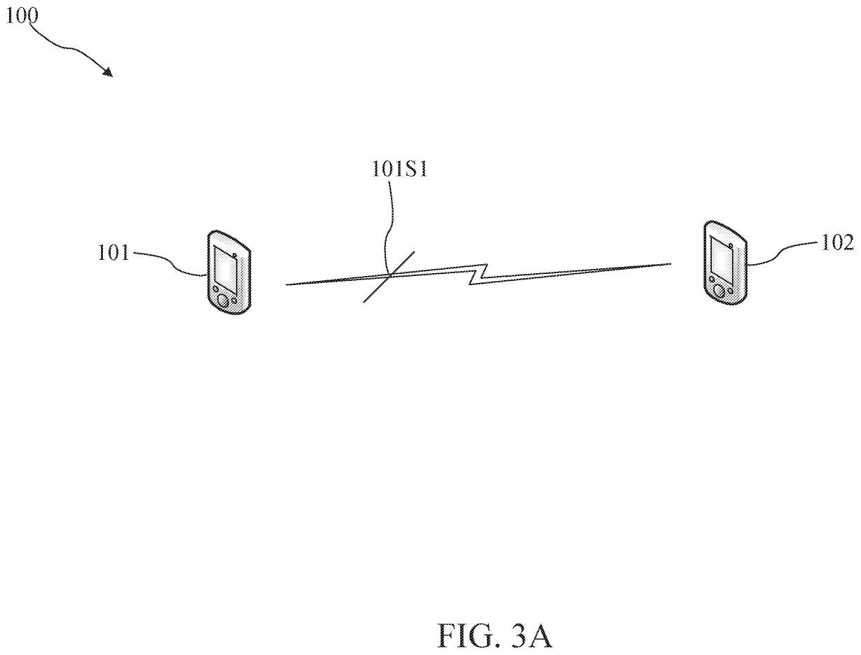

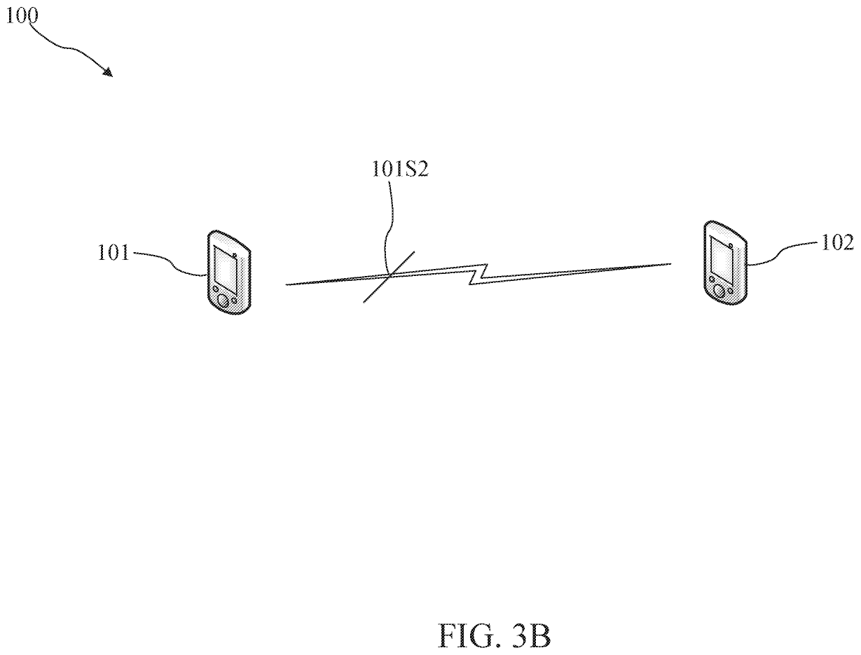

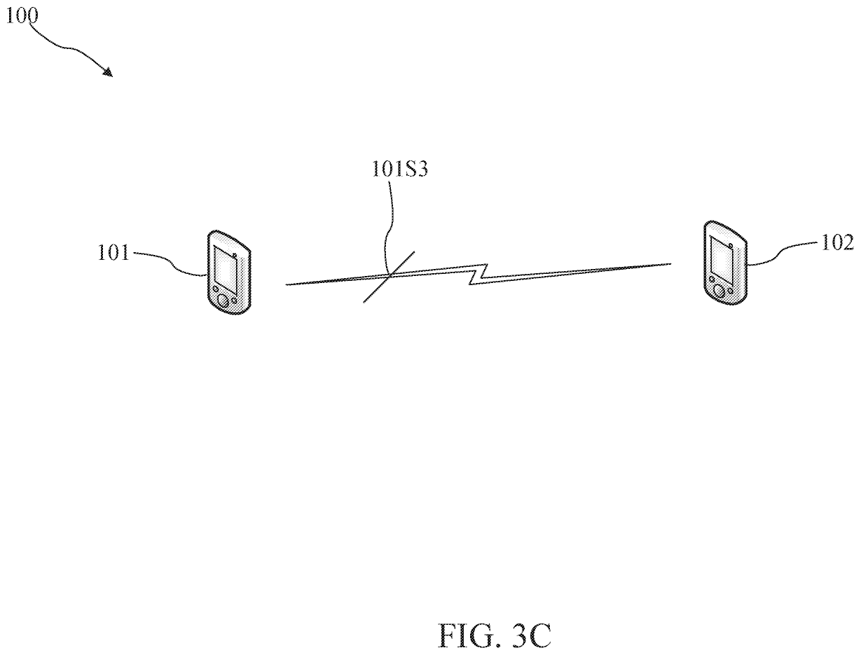

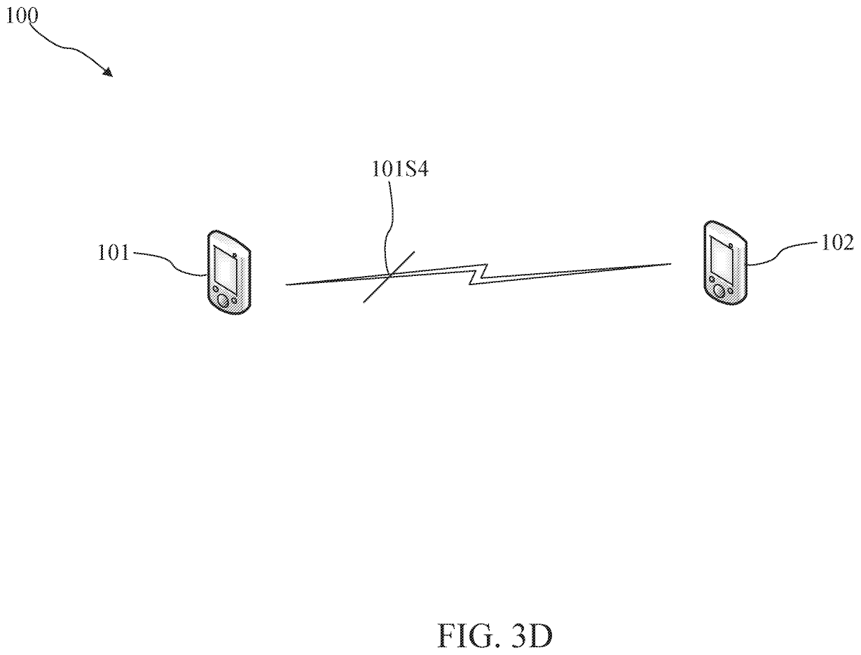

In some implementations, as shown in FIG. 3A, UE 101 may transmit a sidelink control information (SCI) 101S1 to UE 102, and the SCI 101S1 may include a field of indicating UE 102 whether to start the inactivity timer. In particular, after UE 101 determines to start the inactivity timer, UE 101 may set a value of the field in the SCI 101S1 to indicate UE 102 whether to start the inactivity timer.

For example, when UE 101 determines to start the inactivity timer, UE 101 sets the value of the field of the SCI 101S1 to “1” and transmits the SCI 101S1 to UE 102. After UE 102 receives the SCI 101S1 which indicate a new transmission, UE 102 checks the field of the SCI 101S1 and determines to start the inactivity timer because the value of the field is “1”. When UE 101 determines not to start the inactivity timer, UE 101 sets the value of the field of the SCI to “0” and transmits the SCI 101S1 to UE 102. After UE 102 receives the SCI 101S1 which indicate a new transmission, UE 102 checks the field of the SCI 101S1 and determines not to start the inactivity timer because the value of the field is “0”.

In some implementations, as shown in FIG. 3B. UE 101 may indicate UE 102 whether to start the inactivity timer by transmitting an SCI 101S2 to UE 102 during a duration of an on-duration timer which is associated with another QoS configured with the inactivity timer.

For example, when UE 101 determines to start the inactivity timer, UE 101 transmits the SCI 101S2 for physical sidelink shared channel (PSSCH) to UE 102 during the duration of the on-duration timer associated with QoS “X” which is configured with the inactivity timer. When UE 102 receives the SCI 101S2 indicating a new transmission during the duration of the on-duration timer associated with QoS “X” configured with the inactivity timer, UE 102 starts the inactivity timer.

It should be further noted that, in some cases, when a new transmission happens between UE 101 and UE 102 during a duration of that only the inactivity timer is running (e.g., the duration of the inactivity timer does not overlap the duration of the on-duration timer), UE 101 and UE 102 may start the inactivity timer. In some case, when a new transmission happens between UE 101 and UE 102 during a duration of that the inactivity timer and the on-duration timer are running (e.g., the duration of the inactivity timer overlaps the duration of the on-duration timer). UE 101 and UE 102 may start the inactivity timer if the QoS associated with the on-duration timer is configured with the inactivity timer.

In some implementations, as shown in FIG. 3C. UE 101 may utilize a priority of an SCI 101S3 to indicate UE 102 whether to start the inactivity timer. In particular, after UE 101 determine to start the inactivity timer, UE 101 may transmit the SCI 101S3 to UE 102 while the SCI 101S3 includes a priority whose value is higher than a threshold or the priority is configured to enable the inactivity timer.

For example, when UE 101 determines to start the inactivity timer, and the priority value in SCI 101S3 is higher than the threshold and transmits the SCI 101S3 to UE 102. When UE 102 receives the SCI 101S3 which indicate a new transmission. UE 102 checks the priority and determines to start the inactivity timer because the value of the priority is higher than the threshold. When UE 101 determines not to start the inactivity timer, and the priority value in SCI 101S3 is lower than the threshold and transmits the SCI 101S3 to UE 102. When UE 102 receives the SCI 101S3 which indicate a new transmission, UE 102 checks the priority and determines not to start the inactivity timer because the value of the priority is lower than the threshold.

For another example, when UE 101 determines to start the inactivity timer and the priority in SCI 101S3 is configured to enable inactivity timer, UE 101 transmits the SCI 101S3 to UE 102. When UE 102 receives the SCI 101S3 which indicate a new transmission, UE 102 checks the priority and determines to start the inactivity timer because the value of the priority is configured to enable inactivity timer. When UE 101 determines not to start the inactivity timer and the priority in SCI 101S3 is not configured to enable inactivity timer, UE 101 transmits the SCI 101S3 to UE 102. When UE 102 receives the SCI 101S3 which indicate a new transmission. UE 102 checks the priority and determines not to start the inactivity timer because the value of the priority is not configured to enable inactivity timer.

In some embodiments, as shown in FIG. 3D, when UE 102 receives an SCI 101S4 indicating a new transmission from UE 101, UE 102 starts the inactivity timer for the reception of the SCI 101S4.

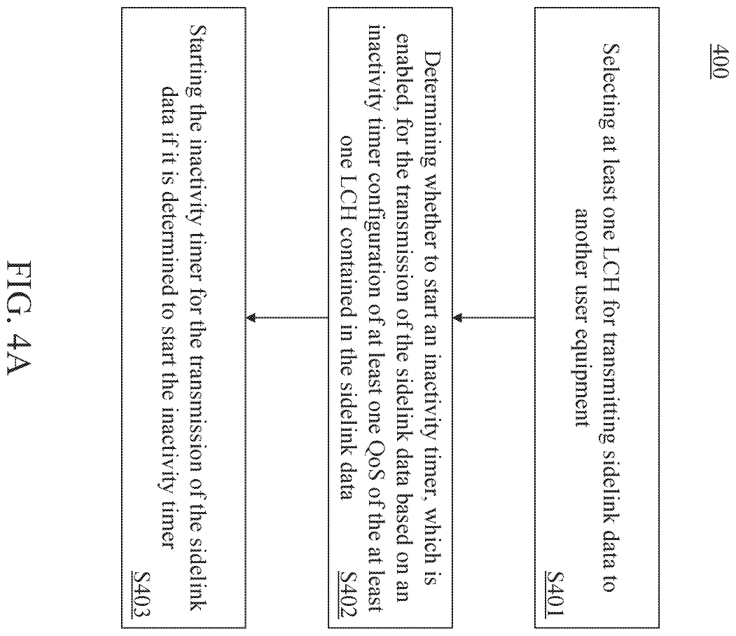

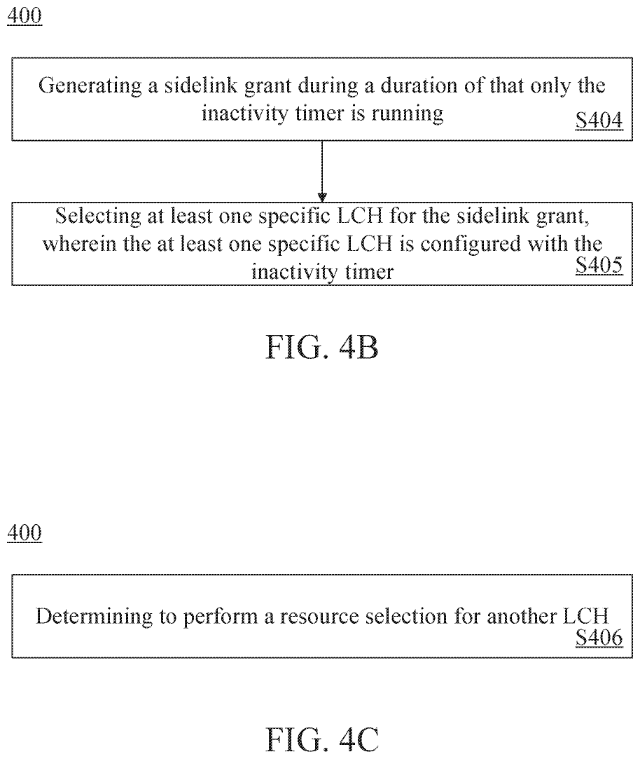

FIGS. 4A to 4C illustrate flow charts of a method for wireless communications in accordance with some embodiments of the present application. Referring to FIGS. 4A to 4C, method 400 is performed by a UE (e.g., UE 101) in some embodiments of the present application.

In some embodiments, operation S401 is executed to select, by the UE, at least one LCH for transmitting sidelink data to another UE. Operation S402 is executed to determine, by the UE, whether to start an inactivity timer, which is enabled, for the transmission of the sidelink data based on an inactivity timer configuration of at least one QoS of the at least one LCH contained in the sidelink data. If it is determined to start the inactivity timer, operation S403 is executed to start, by the UE, the inactivity timer for the transmission of the sidelink data.

In some embodiments, the inactivity timer configuration may be used to configure the UE to determine to start the inactivity timer for the transmission of the sidelink data based on that: (1) a specific QoS of a specific LCH of the at least one LCH is configured with the inactivity timer; or (2) every QoS of the at least one LCH is configured with the inactivity timer.

In some implementations, the specific QOS of the specific LCH of the at least one LCH being configured with the inactivity timer may be: (1) if any LCH of the at least one LCH is associated with QoS that configured with inactivity timer; (2) if the LCH with highest priority is associated with QoS that configured with the inactivity timer; or (3) if one LCH whose priority value is higher than a threshold is associated with QoS that configured with the inactivity timer.

Accordingly, for example, the UE determines to start the inactivity timer for the transmission of the sidelink data based on that: (1) when one of the at least one LCH is associated with QoS that configured with inactivity timer; (2) when the LCH with highest priority is associated with QoS that configured with the inactivity timer; or (3) when one LCH whose priority value is higher than a threshold is associated with QoS that configured with the inactivity timer.

In some implementations, every QoS of the at least one LCH being configured with the inactivity timer may be: if all of the at least one LCH is associated with QoS that configured with the inactivity timer. Accordingly, for example, the UE determines to start the inactivity timer for the transmission of the sidelink data based on that: when all of the at least one LCH is associated with QoS that configured with the inactivity timer.

In some embodiments, operations S404 and S405 may be optionally executed. Operation S404 is executed to generate, by the UE, a sidelink grant during a duration of that only the inactivity timer is running. Operation S405 is executed to select, by the UE, at least one specific LCH for the sidelink grant, wherein the at least one specific LCH is configured with the inactivity timer.

In some embodiments, operation S406 may be optionally executed. Operation S406 is executed to determine, by the UE, to perform a resource selection for another LCH. A resource during a duration of that only the inactivity timer is running is selected when the another LCH is configured with the inactivity timer. The resource during the duration of that only the inactivity timer is running is not selected when the another LCH is not configured with the inactivity timer.

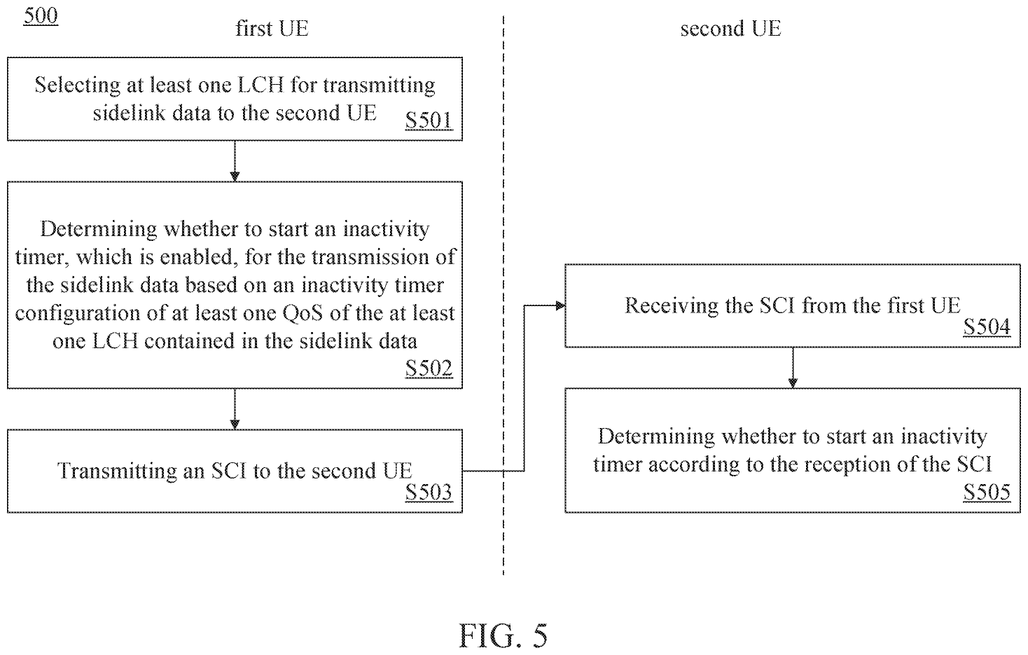

FIG. 5 illustrates a flow chart of a method for wireless communications in accordance with some embodiments of the present application. Referring to FIG. 5, method 500 is performed by a first UE (e.g., UE 101) and a second (e.g., UE 102) in some embodiments of the present application.

In some embodiments, operation S501 is executed to select, by the first UE, at least one LCH for transmitting sidelink data to the second UE. Operation S502 is executed to determine, by the first UE, whether to start an inactivity timer, which is enabled, for the transmission of the sidelink data based on an inactivity timer configuration of at least one QoS of the at least one LCH contained in the sidelink data.

Operation S503 is executed to transmit, by the first UE, an SCI to the second UE. Operation S504 is executed to receive, by the second UE, the SCI from the first UE. Operation S505 is executed to determine, by the second UE, whether to start an inactivity timer according to the reception of the SCI.

In some implementations, the SCI may include a field of indicating the second UE whether to start the inactivity timer. In particular, after the first UE determines to start the inactivity timer, the first UE may set a value of the field in the to indicate the second UE whether to start the inactivity timer.

In some implementations, the first UE may indicate the second UE whether to start the inactivity timer by transmitting the SCI to the second UE during a duration of an on-duration timer which is associated with another QoS configured with the inactivity timer.

It should be further noted that, in some cases, when a new transmission happens between the first UE and the second UE during a duration of that only the inactivity timer is running (e.g., the duration of the inactivity timer does not overlap the duration of the on-duration timer), the first UE and the second UE may start the inactivity timer. In some case, when a new transmission happens between the first UE and the second UE during a duration of that the inactivity timer and the on-duration timer are running (e.g., the duration of the inactivity timer overlaps the duration of the on-duration timer), the first UE and the second UE may start the inactivity timer if the QoS associated with the on-duration timer is configured with the inactivity timer.

In some implementations, the first UE may utilize a priority of the SCI to indicate the second UE whether to start the inactivity timer. In particular, after the first UE determines to start the inactivity timer, the first UE may transmit the SCI to the second UE while the SCI includes a priority whose value is higher than a threshold.

In some implementations, when the second UE receives the SCI indicating a new transmission from the first UE, the second UE starts the inactivity timer for the reception of the SCI.

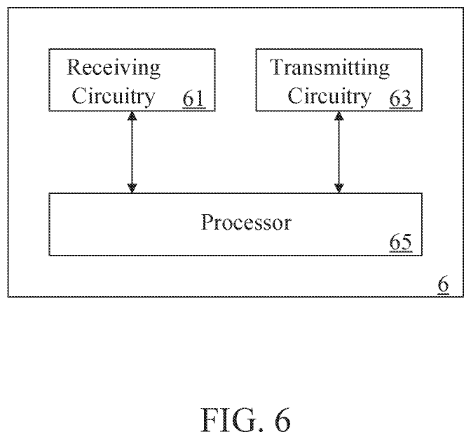

FIG. 6 illustrates an example block diagram of an apparatus 6 according to an embodiment of the present disclosure.

As shown in FIG. 6, the apparatus 6 may include at least one non-transitory computer-readable medium (not illustrated in FIG. 6), a receiving circuitry 61, a transmitting circuitry 63, and a processor 65 coupled to the non-transitory computer-readable medium (not illustrated in FIG. 6), the receiving circuitry 61 and the transmitting circuitry 63. The apparatus 6 may be an UE.

Although in this figure, elements such as processor 65, transmitting circuitry 63, and receiving circuitry 61 are described in the singular, the plural is contemplated unless limitation to the singular is explicitly stated. In some embodiments of the present disclosure, the receiving circuitry 61 and the transmitting circuitry 63 are combined into a single device, such as a transceiver. In certain embodiments of the present disclosure, the apparatus 6 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 6 interacting with receiving circuitry 61 and transmitting circuitry 63, so as to perform the operations with respect to UE depicted in FIGS. 1 to 3D.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising.” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
select at least one logical channel (LCH) for transmitting sidelink data to another UE;
determine whether to start an inactivity timer, which is enabled, for transmission of the sidelink data based on an inactivity timer configuration of at least one quality of service (QOS) of the at least one LCH contained in the sidelink data; and
if it is determined to start the inactivity timer, start the inactivity timer for the transmission of the sidelink data.

2. The UE of claim 1, wherein the at least one processor is configured to cause the UE to start the inactivity timer based on the inactivity timer configuration of at least one QoS of the at least one LCH contained in the sidelink data by:
starting the inactivity timer for the transmission of the sidelink data based on:
a specific QoS of a specific LCH of the at least one LCH is configured with the inactivity timer; or
every QoS of the at least one LCH is configured with the inactivity timer.

3. The UE of claim 1, wherein the at least one processor is configured to cause the UE to:
generate a sidelink grant during a duration of that only the inactivity timer is running; and
select at least one specific LCH for the sidelink grant, wherein the at least one specific LCH is configured with the inactivity timer.

4. The UE of claim 1, wherein the at least one processor is configured to cause the UE to:
determine to perform a resource selection for another LCH,
wherein a resource during a duration of that only the inactivity timer is running is selected when the another LCH is configured with the inactivity timer; and
wherein the resource during the duration of that only the inactivity timer is running is not selected when the another LCH is not configured with the inactivity timer.

5. The UE of claim 1, wherein an active time definition is per LCH,
wherein for a specific LCH configured with the inactivity timer, the active time definition includes a duration of that the inactivity timer is running;
wherein for another specific LCH not configured with the inactivity timer, the active time definition does not include a duration of that the inactivity timer is running.

6. The UE of claim 1, wherein the at least one processor is configured to cause the UE to:
transmit a sidelink control information (SCI) to the another UE, wherein the SCI includes a field of indicating the another UE whether to start the inactivity timer.

7. The UE of claim 1, wherein the at least one processor is configured to cause the UE to:
transmit a sidelink control information (SCI) to the another UE during a duration of an on-duration timer, wherein the on-duration timer is associated with another QoS configured with the inactivity timer.

8. A user equipment (UE), comprising:
at least one memory; and
at least one processor coupled with the at least one memory and configured to cause the UE to:
receive a sidelink control information (SCI) from another UE; and
determine whether to start an inactivity timer according to reception of the SCI.

9. The UE of claim 8, wherein the SCI includes a field of indicating the UE whether to start the inactivity timer, and the at least one processor is configured to cause the UE to determine whether to start the inactivity timer according to the reception of the SCI by:
determining to start the inactivity timer in response to a transmission being a new transmission and the field of the SCI indicates the UE to start the inactivity timer;
wherein the at least one processor is configured to cause the UE to:
receive sidelink data from the another UE; and
start the inactivity timer for the reception of the sidelink data.

10. The UE of claim 8, wherein the SCI is received during a duration of an on-duration timer, and the at least one processor is configured to cause the UE to determine whether to start the inactivity timer according to the reception of the SCI by further comprises:
determining whether to start the inactivity timer in response to a transmission being a new transmission and according to a quality of service (QOS) associated with the on-duration timer.

11. The UE of claim 10, wherein the QoS is configured with the inactivity timer, and the at least one processor is configured to cause the UE to determine whether to start the inactivity timer according to the QoS associated with the on-duration timer by:
determining to start the inactivity timer in response to a new transmission being received during a duration of only the inactivity timer is running;
wherein the at least one processor is configured to cause the UE to:
receive sidelink data from the another UE; and
start the inactivity timer for the reception of the sidelink data.

12. The UE of claim 10, wherein the QoS is configured with the inactivity timer, and the at least one processor is configured to cause the UE to determine whether to start the inactivity timer according to the Qos associated with the on-duration timer by:
determining to start the inactivity timer when a new transmission is received during a duration of both inactivity timer is running and on-duration timer is running, and when the inactivity timer is configured for a quality of service (QoS) associated with the on-duration timer;
wherein the at least one processor is configured to cause the UE to:
receive sidelink data from the another UE; and
start the inactivity timer for the reception of the sidelink data.

13. The UE of claim 8, wherein the SCI includes a priority, and the at least one processor is configured to cause the UE to determine whether to start the inactivity timer according to the reception of the SCI further by:
determining to start the inactivity timer in response to a transmission being a new transmission and the priority is associated with the inactivity timer;
wherein the at least one processor is configured to cause the UE to:
receive sidelink data from the another UE; and
start the inactivity timer for the reception of the sidelink data.

14. The UE of claim 8, wherein the at least one processor is configured to cause the UE to:
receive sidelink data indicating a new transmission from the another UE; and
start the inactivity timer for the reception of the sidelink data.

15. (canceled)

16. A processor for wireless communication, comprising:
at least one controller coupled with at least one memory and configured to cause the processor to:
select at least one logical channel (LCH) for transmitting sidelink data to another user equipment (UE);
determine whether to start an inactivity timer, which is enabled, for transmission of the sidelink data based on an inactivity timer configuration of at least one quality of service (QOS) of the at least one LCH contained in the sidelink data; and
in response to it being determined to start the inactivity timer, start the inactivity timer for the transmission of the sidelink data.

17. The processor of claim 16, wherein the at least one controller is configured to cause the processor to start the inactivity timer based on the inactivity timer configuration of at least one QoS of the at least one LCH contained in the sidelink data by:
starting the inactivity timer for the transmission of the sidelink data based on:
a specific QoS of a specific LCH of the at least one LCH is configured with the inactivity timer; or
every QoS of the at least one LCH is configured with the inactivity timer.

18. The processor of claim 16, wherein the at least one controller is configured to cause the processor to:
generate a sidelink grant during a duration of that only the inactivity timer is running; and
select at least one specific LCH for the sidelink grant, wherein the at least one specific LCH is configured with the inactivity timer.

19. A processor for wireless communication, comprising:
at least one controller coupled with at least one memory and configured to cause the processor to:
receive a sidelink control information (SCI) from another user equipment (UE); and
determine whether to start an inactivity timer according to reception of the SCI.

20. The processor of claim 19, wherein the SCI includes a field of indicating the UE whether to start the inactivity timer, and the at least one controller is configured to cause the processor to determine whether to start the inactivity timer according to the reception of the SCI by:
determining to start the inactivity timer in response to a transmission being a new transmission and the field of the SCI indicates the UE to start the inactivity timer;
wherein the at least one controller is configured to cause the processor to:
receive sidelink data from the another UE; and
start the inactivity timer for the reception of the sidelink data.

21. The processor of claim 19, wherein the SCI is received during a duration of an on-duration timer, and the at least one controller is configured to cause the processor to determine whether to start the inactivity timer according to the reception of the SCI by:
determining whether to start the inactivity timer in response to a transmission being a new transmission and according to a quality of service (QOS) associated with the on-duration timer.
